(19) United States
(12) Patent Application Publication
(10) Pub. No.: US 2025/0019090 A1
(43) Pub. Date: Jan. 16, 2025

(54) DYNAMIC FLIGHT ENVELOPE PROTECTION AND DEGRADED FLIGHT STATE OPERATIONS IN A VEHICLE CONTROL AND INTERFACE SYSTEM

(71) Applicant: Skyryse, Inc., El Segundo, CA (US)

(72) Inventors: Mark Daniel Groden, Marina del Rey, CA (US); Will Fulton, El Segundo, CA (US); Justin Mark Ryan, Rancho Palos Verdes, CA (US); Rushabh Chandrakant Patel, Los Angeles, CA (US); Chad Louis Bickel, Redondo Beach, CA (US); Michael Yuan, Los Angeles, CA (US)

(21) Appl. No.: 18/773,458

(22) Filed: Jul. 15, 2024

Related U.S. Application Data
(60) Provisional application No. 63/526,639, filed on Jul. 13, 2023.

(51) Int. Cl. B64D 43/00; G06F 3/04847

(52) U.S. Cl. CPC B64D 43/00; G06F 3/04847

(57) ABSTRACT

A vehicle control and interface system configured to provide dynamic flight envelope protection of an aerial vehicle is described. In particular, the system dynamically calculates allowable trajectory limits for each axis of control through all phases of flight of an aerial vehicle and provides a visualization of the calculated limits on a graphical user interface. During normal operation, the system does not allow the operator to exceed the calculated limits. Responsive to receiving specified user input to modify vehicle navigation, however, the system causes the aircraft to enter an extended envelope by degrading vehicle parameters according to a hierarchy. Moreover, the system is configured to allow the vehicle to operate in a degraded flight state during a prolonged loss of a sensor signal by setting an adjustable hover trim position of each inceptor device and allowing an operator to control horizontal acceleration of the vehicle.

### CROSS REFERENCE TO RELATED APPLICATIONS

This application claims the benefit of U.S. Provisional Application No. 63/526,639, filed Jul. 13, 2023, which is incorporated by reference herein in its entirety.

### TECHNICAL FIELD

The disclosure generally relates to the field of vehicle control systems, and particularly to a system configured to provide dynamic flight envelope protection of an aerial vehicle and to allow the aerial vehicle to operate in a degraded flight state.

### BACKGROUND

Vehicle control and interface systems, such as control systems for aerial vehicles (e.g., rotorcraft or fixed wing aerial vehicle), often require specialized knowledge and training for operation by a human operator. The specialized knowledge and training is necessitated, for instance, by the complexity of the control systems and safety requirements of the corresponding vehicles. Moreover, vehicle control and interface systems are specifically designed for types or versions of certain vehicles. For example, specific rotorcraft and fixed wing aerial vehicle control systems are individually designed for their respective contexts. As such, even those trained to operate one vehicle control system may be unable to operate another control system for the same or similar type of vehicle without additional training. Although some conventional vehicle control systems provide processes for partially or fully automated vehicle control, such systems are still designed for individual vehicle contexts.

Moreover, operators of these aerial vehicles are often faced with making continuous performance trades to maintain the overall air vehicle system within flight, performance, and airframe limitations. This constant mental calculus and systems cross-checking greatly contributes to operator overload while reducing overall situational awareness in complex aerospace environments. Where the aircraft enters a degraded state, such as a failure of one or more sensors, conventional vehicles are typically incapable of functioning within safe operating limits and require an operator to land the craft immediately.

As such, improved vehicle control and interface systems are needed that (1) maintain an aircraft within dynamically calculated air vehicle limitations during normal flight and (2) allow the aircraft to continue operation in a degraded flight state when sensor loss is detected.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a vehicle control and interface system, in accordance with one or more embodiments.

FIG. 2 illustrates one embodiment of a schematic diagram for a universal avionics control router in a redundant configuration, in accordance with one or more embodiments.

FIG. 3 illustrates a configuration for a set of universal vehicle control interfaces in a vehicle, in accordance with one or more embodiments.

FIG. 4 illustrates one example embodiment of an interface of an aerial vehicle operating in a degraded state.

FIG. 5 illustrates one example embodiment of an interface for an aerial vehicle in a normal dynamic flight envelope protection range.

FIG. 6 is a flowchart of a process for modifying a graphical user interface (GUI) based on degraded axis movement of an aerial vehicle, in accordance with one embodiment.

FIG. 7 is a flowchart of a process for modifying a navigation and a GUI of an aerial vehicle responsive to the aerial vehicle operating in a degraded state, in accordance with one embodiment.

FIG. 8 is a block diagram illustrating one example embodiment of components of an example machine able to read instructions from a machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Embodiments of a disclosed system, method and a non-transitory computer readable storage medium that includes a vehicle control and interface system for controlling different vehicles through universal mechanisms. The vehicle control and interface system may be integrated with different types of vehicles (e.g., rotorcraft, fixed-wing aircraft, motor vehicles, watercraft, etc.) in order to facilitate operation of the different vehicles using universal vehicle control inputs. In particular, the vehicle control and interface system receives vehicle control inputs from one or more universal vehicle control interfaces describing a requested trajectory of the vehicle. The vehicle control and interface system converts (or translates) the vehicle control inputs into commands for specific actuators of the vehicle configured to achieve the requested trajectory. By way of example, to convert the vehicle control inputs to actuator commands, the vehicle control and interface system processes the inputs using a universal vehicle control router.

In example embodiments, the vehicle control and interface system is configured to provide dynamic flight envelope protection of an aerial vehicle. In particular, the system dynamically calculates allowable trajectory limits for each axis of control through all phases of flight of an aerial vehicle and provides a visualization of the calculated limits on a graphical user interface. For example, the system can generate barber poles on speed, altitude, and heading indicators of a GUI for operating an aerial vehicle and dynamically update the format of the barber poles (e.g., size or shading) to reflect the dynamically changing limits that the system is calculating for the vehicle's operation. During normal operation of the vehicle, the system does not allow the operator to exceed the calculated limits. The user, with specified input, can intentionally modify vehicle navigation and cause the aircraft to enter an extended envelope by degrading vehicle parameters according to a hierarchy.

Moreover, the system is configured to allow the vehicle to operate in a degraded flight state during a prolonged loss of a sensor signal by automatically setting a hover trim position of each inceptor device. The hover trim position is set to maintain a center state of the inceptor device with an appropriate center state of a vehicle attitude. Once the hover trim position is set, the operator may use the inceptor device to control horizontal acceleration of the vehicle.

### Example System Environment

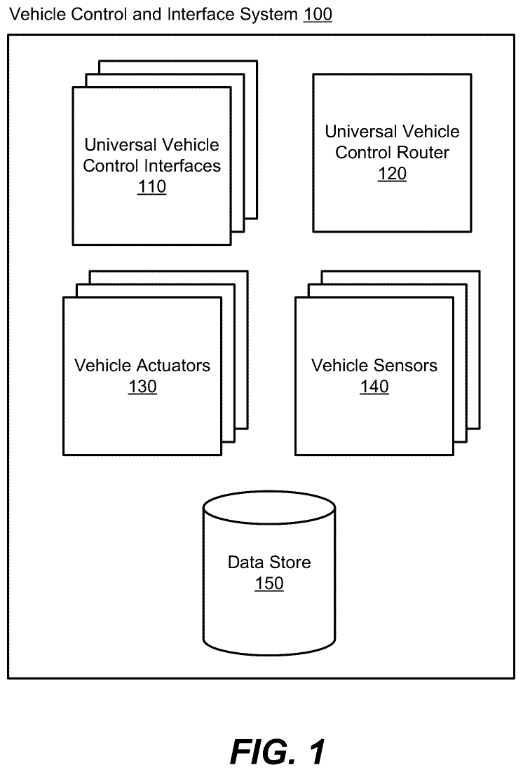

Figure (FIG. 1 illustrates one example embodiment of a vehicle control and interface system 100. In the example embodiment shown, vehicle control and interface system 100 includes one or more universal vehicle control interfaces 110, universal vehicle control router 120, one or more vehicle actuators 130, one or more vehicle sensors 140, and one or more data stores 150. In other embodiments, the vehicle control and interface system 100 may include different or additional elements. Furthermore, the functionality may be distributed among the elements in a different manner than described. The elements of FIG. 1 may include one or more computers that communicate via a network or other suitable communication method.

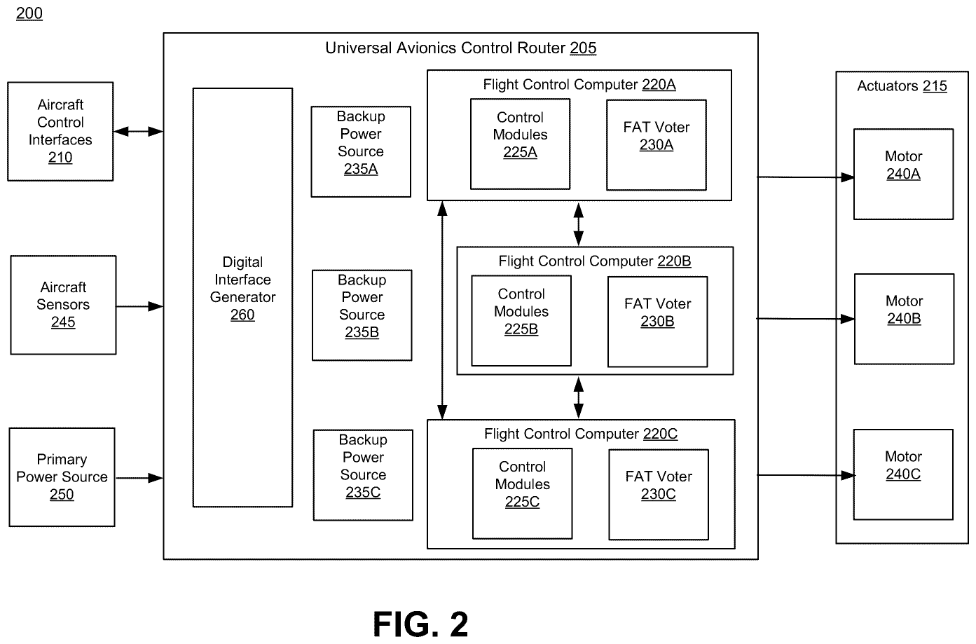

The vehicle control and interface system 100 may be integrated with various vehicles having different mechanical, hardware, or software components. For example, the vehicle control and interface system 100 may be integrated with fixed-wing aircraft (e.g., airplanes), rotorcraft (e.g., helicopters), motor vehicles (e.g., automobiles), watercraft (e.g., power boats or submarines), or any other suitable vehicle. As described in greater detail below with reference to FIGS. 2-8, the vehicle control and interface system 100 is advantageously configured to receive inputs for requested operation of a particular vehicle via universal set of interfaces and the inputs to appropriate instructions for mechanical, hardware, or software components of the particular vehicle to achieve the requested operation. In doing so, the vehicle control and interface system 100 enables human operators to operate different vehicles using the same universal set of interfaces or inputs. By way of example, “universal” indicates that a feature of the vehicle control and interface system 100 may operate or be architected in a vehicle-agnostic manner. This allows for vehicle integration without necessarily having to design and configure vehicle specific customizations or reconfigurations in order to integrate the specific feature. Although universal features of the vehicle control and interface system 100 can function in a vehicle-agnostic manner, the universal features may still be configured for particular contexts. For example, the vehicle control or interface system 100 may receive or process inputs describing three-dimensional movements for vehicles that can move in three dimensions (e.g., aircraft) and conversely may receive or process inputs describing two-dimensional movements for vehicles that can move in two dimensions (e.g., automobiles). One skilled in the art will appreciate that other context-dependent configurations of universal features of the vehicle control and interface system 100 are possible.

The universal vehicle control interfaces 110 is a set of universal interfaces configured to receive a set of universal vehicle control inputs to the vehicle control and interface system 100. The universal vehicle control interfaces 110 may include one or more digital user interfaces presented to an operator of a vehicle via one or more electronic displays. Additionally, or alternatively, the universal vehicle control interfaces 110 may include one or more hardware input devices, e.g., one or more control sticks inceptors, such as side sticks, center sticks, throttles, cyclic controllers, or collective controllers. The universal vehicle control interfaces 110 receive universal vehicle control inputs requesting operation of a vehicle. In particular, the inputs received by the universal vehicle control interfaces 110 may describe a requested trajectory of the vehicle, such as to change a velocity of the vehicle in one or more dimensions or to change an orientation of the vehicle. Because the universal vehicle control inputs describe an intended trajectory of a vehicle directly rather than describing vehicle-specific precursor values for achieving the intended trajectory, such as vehicle attitude inputs (e.g., power, lift, pitch, roll yaw), the universal vehicle control inputs can be used to universally describe a trajectory of any vehicle. This is in contrast to existing systems where control inputs are received as vehicle-specific trajectory precursor values that are specific to the particular vehicle. Advantageously, any individual interface of the set of universal vehicle control interfaces 110 configured to received universal vehicle control inputs can be used to completely control a trajectory of a vehicle. This is in contrast to conventional systems, where vehicle trajectory must be controlled using two or more interfaces or inceptors that correspond to different axes of movement or vehicle actuators. For instance, conventional rotorcraft systems include different cyclic (controlling pitch and roll), collective (controlling heave), and pedal (controlling yaw) inceptors. Similarly, conventional fixed-wing aircraft systems include different stick or yoke (controlling pitch and roll), power (controlling forward movement), and pedal (controlling yaw) inceptors.

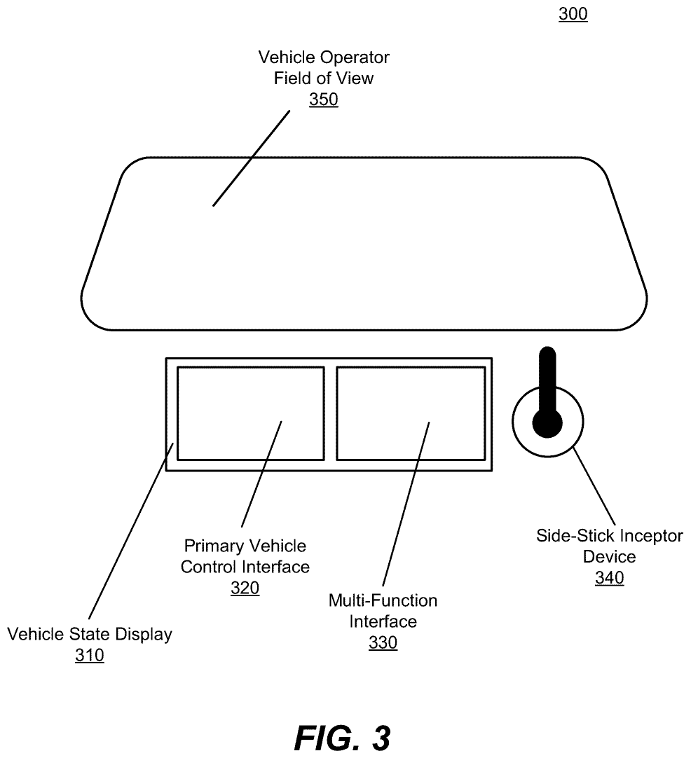

In various embodiments, inputs received by the universal vehicle control interfaces 110 can include “steady-hold” inputs, which may be configured to hold a parameter value fixed (e.g., remain in a departed position) without a continuous operator input. Such variants can enable hands-free operation, where discontinuous or discrete inputs can result in a fixed or continuous input. In a specific example, a user of the universal vehicle control interfaces 110 can provide an input (e.g., a speed input) and subsequently remove their hands with the input remaining fixed. Alternatively, or additionally, inputs received by the universal vehicle control interfaces 110 can include one or more self-centering or automatic return inputs, which return to a default state without a continuous user input. As described in more detail below with respect to FIG. 3, in one embodiment, an operator can provide input to hold multiple axes and subsequently remove hold (e.g., via deflection of a mechanical controller, such as the side-stick inceptor device 340) from a selected axis while holds of other axes are maintained.

In some embodiments, the universal vehicle control interfaces 110 include interfaces that provide feedback information to an operator of the vehicle. For instance, the universal vehicle control interfaces 110 may provide information describing a state of a vehicle integrated with the universal vehicle control interfaces 110 (e.g., current vehicle speed, direction, orientation, location, etc.). Additionally, or alternatively, the universal vehicle control interfaces 110 may provide information to facilitate navigation or other operations of a vehicle, such as visualizations of maps, terrain, or other environmental features around the vehicle.

The universal vehicle control router 120 routes universal vehicle control inputs describing operation of a vehicle to components of the vehicle suitable for executing the operation. In particular, the universal vehicle control router 120 receives universal vehicle control inputs describing the operation of the vehicle, processes the inputs using information describing characteristics of the aircraft, and outputs a corresponding set of commands for actuators of the vehicle (e.g., the vehicle actuators 130) suitable to achieve the operation. The universal vehicle control router 120 may use various information describing characteristics of a vehicle in order to convert universal vehicle control inputs to a suitable set of commands for actuators of the vehicle. Additionally, or alternatively, the universal vehicle control router 120 may convert universal vehicle control inputs to a set of actuator commands using a set of control laws that enforce constraints (e.g., limits) on operations requested by the universal control inputs. For example, the set of control laws may include velocity limits (e.g., to prevent stalling in fixed-wing aircraft), acceleration limits, turning rate limits, engine power limits, rotor revolution per minute (RPM) limits, load power limits, allowable descent altitude limits, etc. After determining a set of actuator commands, the universal vehicle control router 120 may transmit the commands to relevant components of the vehicle for causing corresponding actuators to execute the commands and generate and provide graphical user interfaces with indications of the determined limits. Embodiments of the universal vehicle control router 120 are described in greater detail below with reference to FIG. 3.

The universal vehicle control router 120 can decouple axes of movement for a vehicle to process received universal vehicle control inputs. In particular, the universal vehicle control router 120 can process a received universal vehicle control input for one axis of movement without impacting other axes of movement such that the other axes of movement remain constant. In this way, the universal vehicle control router 120 can facilitate “steady-hold” vehicle control inputs, as described above with reference to the universal vehicle control interfaces 110. This is in contrast to conventional systems, where a vehicle operator must manually coordinate all axes of movement independently for a vehicle in order to produce movement in one axis (e.g., a pure turn, a pure altitude climb, a pure forward acceleration, etc.) without affecting the other axes of movement.

In some embodiments, the universal vehicle control router 120 is configured to use one or more models corresponding to a particular vehicle to convert universal vehicle control inputs to a suitable set of commands for actuators of the vehicle. For example, a model may include a set of parameters (e.g., numerical values) that can be used as input to universal input conversion processes to generate actuator commands suitable for a particular vehicle. In this way, the universal vehicle control router 120 can be integrated with vehicles by substituting models used by processes of the universal vehicle control router 120, enabling efficient integration of the vehicle control and interface system 100 with different vehicles. The one or more models may be obtained by the universal vehicle control router 120 from a vehicle model database or other first-party or third-party system, e.g., via a network. In some cases, the one or more models may be static after integration with the vehicle control and interface system 100, such as if a vehicle integrated with the vehicle control and interface system 100 receives is certified for operation by a certifying authority (e.g., the United States Federal Aviation Administration). In some embodiments, parameters of the one or more models are determined by measuring data during real or simulated operation of a corresponding vehicle and fitting the measured data to the one or more models.

In some embodiments, the universal vehicle control router 120 processes universal vehicle control inputs according to a current phase of operation of the vehicle. For instance, if the vehicle is a rotorcraft, the universal vehicle control router 120 may convert a universal input describing an increase in lateral speed to one or more actuator commands differently if the rotorcraft is in a hover-taxi or in a forward flight phase. In particular, in processing the lateral speed increase universal input the universal vehicle control router 120 may generate actuator commands causing the rotorcraft to strafe if the rotorcraft is hovering and causing the rotorcraft to turn if the rotorcraft is in forward flight. As another example, in processing a turn speed increase universal input the universal vehicle control router 120 may generate actuator commands causing the rotorcraft to perform a pedal turn if the rotorcraft is hovering and ignore the turn speed increase universal input if the rotorcraft is in another phase of operation. As a similar example for a fixed-wing aircraft, in processing a turn speed increase universal input the universal vehicle control router 120 may generate actuator commands causing the fixed-wing aircraft to perform tight ground turn if the fixed-wing aircraft is grounded and ignore the turn speed increase universal input if the fixed-wing aircraft is in another phase of operation. One skilled in the art will appreciate that the universal vehicle control router 120 may perform other suitable processing of universal vehicle control inputs to generate actuator commands in consideration of vehicle operation phases for various vehicles.

The vehicle actuators 130 are one or more actuators configured to control components of a vehicle integrated with the universal vehicle control interfaces 110. For instance, the vehicle actuators may include actuators for controlling a power-plant of the vehicle (e.g., an engine). Furthermore, the vehicle actuators 130 may vary depending on the particular vehicle. For example, if the vehicle is a rotorcraft the vehicle actuators 130 may include actuators for controlling lateral cyclic, longitudinal cyclic, collective, and pedal controllers of the rotorcraft. As another example, if the vehicle is a fixed-wing aircraft the vehicle actuators 130 may include actuators for controlling a rudder, elevator, ailerons, and power-plant of the fixed-wing aircraft.

The vehicle sensors 140 are sensors configured to capture corresponding sensor data. In various embodiments the vehicle sensors 140 may include, for example, one or more global positioning system (GPS) receivers, inertial measurement units (IMUs), accelerometers, gyroscopes, magnometers, pressure sensors (altimeters, static tubes, pitot tubes, etc.), temperature sensors, vane sensors, range sensors (e.g., laser altimeters, radar altimeters, lidars, radars, ultrasonic range sensors, etc.), terrain elevation data, geographic data, airport or landing zone data, rotor revolutions per minute (RPM) sensors, manifold pressure sensors, or other suitable sensors. In some cases, the vehicle sensors 140 may include, for example, redundant sensor channels for some or all of the vehicle sensors 140. The vehicle control and interface system 100 may use data captured by the vehicle sensors 140 for various processes. By way of example, the universal vehicle control router 120 may use vehicle sensor data captured by the vehicle sensors 140 to determine an estimated state of the vehicle.

The data store 150 is a database storing various data for the vehicle control and interface system 100. For instance, the data store 150 may store sensor data (e.g., captured by the vehicle sensors 140), vehicle models, vehicle metadata, or any other suitable data.

### Example Universal Avionics Control Router

FIG. 2 illustrates one embodiment of a schematic diagram 200 for a universal avionics control router 205 in a redundant configuration, in accordance with one embodiment. The universal avionics control router 205 may be an embodiment of the universal vehicle control router 120. Although the embodiment depicted in FIG. 2 is particularly directed to operating an aerial vehicle (e.g., a rotorcraft or fixed wing aerial vehicle), one skilled in the art will appreciate that similar systems can be used with other vehicles, such as motor vehicles or watercraft.

Aerial vehicle control interfaces 210 are configured to provide universal aerial vehicle control inputs to the universal avionics control router 205. The aerial vehicle control interfaces 210 may be embodiments of the universal vehicle control interfaces 110. In particular, the aerial vehicle control interfaces 210 may include an inceptor device, a gesture interface, and an automated control interface. The aerial vehicle control interfaces 210 may be configured to receive instructions from a human pilot as well as instructions from an autopilot system and convert the instructions into universal aerial vehicle control inputs to the universal avionics control router 205. At a given time, the universal aerial vehicle control inputs may include inputs received from some or all of the aerial vehicle control interfaces 210. Inputs received from the aerial vehicle control interfaces 210 are routed to the universal avionics control router 205. The aerial vehicle control interfaces 210 may generate multiple sets of signals, such as one set of signals for each flight control channel via separate wire harnesses and connectors. Inputs received by the aerial vehicle control interfaces 210 may include information for selecting or configuring automated control processes, such as automated aerial vehicle control macros (e.g., macros for aerial vehicle takeoff, landing, or autopilot) or automated mission control (e.g., navigating an aerial vehicle to a target location in the air or ground).

The universal avionics control router 205 includes a digital interface generator 260 that is configured to generate and update one or more graphical user interfaces (GUIs) of the aerial vehicle control interfaces 210. The digital interface generator 260 may be a software module executed on a computer of the universal avionics control router 205. The digital interface generator 260 may generate an interface to prepare the vehicle for operation, an interface to control the navigation of the vehicle, an interface to end the operation of the vehicle, any suitable interface for controlling operation of the vehicle, or a combination thereof. The digital interface generator 260 may update the generated GUIs based on measurements taken by the aerial vehicle sensors 245, user inputs received via the aerial vehicle control interfaces 210, or a combination thereof. In particular, the digital interface generator 260 may update the generated GUIs based on determinations by one or more of the flight control computers 220A, 220B, 220C (collectively 220).

The universal avionics control router 205 is configured to convert the inputs received from the aerial vehicle control interfaces 210 into instructions to an actuator 215 configured to move an aerial vehicle component. The universal avionics control router 205 includes flight control computers 220. Each flight control computer 220 includes control modules 225A, 225B, 225C (collectively 225), a FAT voter 230A, 230B, 230C (collectively 230), and one or more processors (not shown). Each flight control computer 220 is associated with a backup power source 235A, 235B, 235C (collectively 235) configured to provide power to the associated flight control computer 220. In the illustrated embodiment, the universal avionics flight control router 205 includes three flight control computers 220. However, in other embodiments, the universal avionics control router 205 may include two, four, five, or any other suitable number of flight control computers 220.

Each flight control computer 220 is configured to receive inputs from the aerial vehicle control interfaces 210 and provide instructions to actuators 215 configured to move aerial vehicle components in a redundant configuration. Each flight control computer 220 operates in an independent channel from the other flight control computer 220. Each independent channel comprises distinct dedicated components, such as wiring, cabling, servo motors, etc., that is separate from the components of the other independent channels. The independent channel includes the plurality of motors 240 to which the flight control computer provides commands. One or more components of each flight control computer 220 may be manufactured by a different manufacturer, be a different model, or some combination thereof, to prevent a design instability from being replicated across flight control computers 220. For example, in the event that a chip in a processor is susceptible to failure in response to a particular sequence of inputs, having different chips in the processors of the other flight control computers 220 may prevent simultaneous failure of all flight control computers in response to encountering that particular sequence of inputs.

Each flight control computer 220 comprises a plurality of control modules 225 configured to convert inputs from the aerial vehicle control interfaces 210 and aerial vehicle sensors 245 into actuator instructions. The control modules may comprise an automated aerial vehicle control module, an aerial vehicle state estimation module, a sensor validation module, a command processing module, and a control laws module. The automated aerial vehicle control module may be configured to generate a set of universal aerial vehicle control inputs suitable for executing automated control processes. The automated aerial vehicle control module can be configured to determine that an aerial vehicle is ready for flight. The automated aerial vehicle control module may receive measurements taken by the aerial vehicle sensors 245, determine measurements derived therefrom, of a combination thereof. For example, the automated aerial vehicle control module may receive an N1 measurement from a tachometer of the aerial vehicle sensors 245 indicating a rotational speed of a low-pressure engine spool, determine a percent RPM based on an engine manufacturer's predefined rotational speed that corresponds to a maximum rotational speed or 100%, or a combination thereof.

The automated aerial vehicle control module may further be configured to automate the startup of one or more engines of the aerial vehicle. The automated aerial vehicle control module may perform tests during engine startup, which can include multiple stages (e.g., before starting the engine, or “pre-start,” and after starting the engine, or “post-start”). The automated aerial vehicle control module can use measurements taken by sensors of the aerial vehicle (e.g., the vehicle sensors 140) to verify whether one or more of safety criteria or accuracy criteria are met before authorizing the operator to fly the aerial vehicle. The sensor measurements may characterize properties of the engine such as oil temperature, oil pressure, rotational speeds (e.g., N1 or N2), any suitable measurement of an engine's behavior, or combination thereof. For example, the automated aerial vehicle control module may enable the user to increase the engine speed and raise the collective of a helicopter in response to determining that both a first set of safety criteria are met by engine measurements taken before starting the engine, or “pre-start engine parameters,” and a second set of safety criteria are met by engine measurements taken after starting the engine and before takeoff, or “post-start engine parameters.” As referred to herein, a safety criterion may be a condition to be met by a pre-start or post-start engine parameter to determine that one or more actuators of the aerial vehicle are safe to operate. Examples of safety criteria include the engagement of seat belts, a clear area around an aerial vehicle preparing to take off, a target oil pressure or temperature achieved during engine startup, etc. The automated aerial vehicle control module may implement various accuracy and redundancy checks to increase the safety of the automated engine startup. Although the term “automated engine startup” is used herein, the engine startup process may be fully automated or partially automated (e.g., assisted engine startup).

The aerial vehicle state estimation module may be configured to determine an estimated aerial vehicle state of the aerial vehicle using validated sensor signals, such as an estimated 3D position of the vehicle with respect to the center of the Earth, estimated 3D velocities of the aerial vehicle with respect to the ground or with respect to a moving air mass, an estimated 3D orientation of the aerial vehicle, estimated 3D angular rates of change of the aerial vehicle, an estimated altitude of the aerial vehicle, or any other suitable information describing a current state of the aerial vehicle.

The sensor validation module is configured to validate sensor signals captured by the aerial vehicle sensors 245. For example, the sensors may be embodiments of the vehicle sensors 140 described above with reference to FIG. 1. Outputs of the sensor validation module may be used by the automated aerial vehicle control module to verify that the aerial vehicle is ready for operation.

The command processing module is configured to generate aerial vehicle trajectory values using the universal aerial vehicle control inputs. The trajectory values may also be referred to herein as navigation or navigation values. The aerial vehicle trajectory values describe universal rates of change of the aerial vehicle along movement axes of the aerial vehicle in one or more dimensions. The command processing module may be configured to modify non-navigational operation of the aerial vehicle using the universal aerial vehicle control inputs. Non-navigational operation is an operation of the aerial vehicle that does not involve actuators that control the movement of the aerial vehicle. Examples of non-navigational operation includes a temperature inside the cabin, lights within the cabin, a position of an electronic display within the cabin, audio output (e.g., speakers) of the aerial vehicle, one or more radios of the aerial vehicle (e.g., very-high-frequency radios for identifying and communication with ground stations for navigational guidance information), any suitable operation of the aerial vehicle that operates independently of the aerial vehicle's movement, or a combination thereof. The universal aerial vehicle control inputs may be received through GUIs generated by the digital interface generator 260.

The control laws module is configured to generate the actuator commands (or signals) using the aerial vehicle position values. The control laws module includes an outer processing loop and an inner processing loop. The outer processing loop applies a set of control laws to the received aerial vehicle position values to convert aerial vehicle position values to corresponding allowable aerial vehicle position values. The outer processing loop may apply the control laws in order impose various protections or limits on operation of the aircraft, such as aircraft envelope protections, movement range limits, structural protections, aerodynamic protections, impose regulations (e.g., noise, restricted airspace, etc.), or other suitable protections or limits. Moreover, the limit laws may be dynamic, such as varying depending on an operational state of the aircraft, or static, such as predetermined for a particular type of aircraft or type of aircraft control input. As an example, if the aircraft is a rotorcraft the set of control laws applied by the outer processing loop may include maximum and minimum rotor RPMs, engine power limits, aerodynamic limits such as ring vortex, loss of tail-rotor authority, hover lift forces at altitude, boom strike, maximum bank angle, or side-slip limits. As another example, if the aircraft is a fixed-wing aircraft the set of control laws applied by the outer processing loop may include stall speed protection, bank angle limits, side-slip limits, g-loads, flaps or landing gear max extension speeds, or velocity never exceeds (VNEs). Additionally, or alternatively, the outer processing loop uses an estimated aircraft state to convert aircraft trajectory values to corresponding allowable aircraft trajectory values. For instance, the outer processing loop may compare a requested aircraft state described by aircraft trajectory values to the estimated aircraft state in order to determine allowable aircraft trajectory values, e.g., to ensure stabilization of the aircraft.

Conversely, the inner processing loop converts the allowable aerial vehicle position values to the actuator commands configured to operate the aerial vehicle to achieve the allowable aerial vehicle position values. Both the outer processing loop and the inner processing loop are configured to operate independently of the particular aerial vehicle including the universal avionics control router 205. In order to operate independently in this manner, the inner and outer processing loops may use a model including parameters describing characteristics of the aerial vehicle that can be used as input to processes or steps of the outer and inner processing loops. The control laws module may use the actuator commands to directly control corresponding actuators or may provide the actuator commands to one or more other components of the aerial vehicle to be used to operate the corresponding actuators.

In some embodiments, the control laws module establishes dynamic flight envelope protection that prevents an operator of the aircraft from exceeding dynamically calculated limits of an airframe while providing agency to temporarily leave the envelope in certain circumstances (e.g., when an emergency maneuver is required to avoid an unintended or potentially dangerous in-flight incident). In such a configuration, the dynamic flight envelope protection includes a normal envelope state applicable during normal operation of the aircraft in either hover-taxi or forward flight (i.e., below or above an effective translational lift airspeed, respectively) and an extended envelope in which an operator commands the aircraft to exit the normal envelope.

In one example of an emergency maneuver, an operator takes passengers to see friends about an hour away. The airframe may be functioning normally, and roughly thirty minutes into the flight, all systems may be operating normally. Suddenly, the operator may notice an unmarked tower guy wire and jerks the inceptor device right to avoid what may be a catastrophic impact with the unmarked obstacle. The aerial vehicle may react by trading both airspeed and then altitude for maximum right turn rate availability. The vehicle may turn hard to the right following instructions transmitted to actuators of the aerial vehicle based on the user's input instructions and the dynamic flight envelope protection's tradeoffs. Subsequently, a display interface on the vehicle may illuminate with an advisory message, and an aural cue in the operator's headset annunciates “max turn rate,” followed by “flight envelope protection exited.” Once clear of the unmarked guy wire, the operator can level the aerial vehicle, arrests the descent, centers the inceptor device, and the vehicle control and interface system 100 may re-engage a normal operation state. The advisory message disappears and an aural cue in the operator's headset may annunciate, “flight envelope protection restored.”

In the normal envelope state, the outer processing loop of the control laws module dynamically calculates maximum or minimum allowable aircraft trajectory values for each axis of control (e.g., climb/descent rate, indicated airspeed, turn/yaw rate) through all phases of flight and provides the calculated values for display on a primary vehicle control interface, such as the primary vehicle control interface 320 of FIG. 3. While the vehicle operates in this state, the operator cannot exceed the displayed limits. The limits can protect an aerial vehicle operator from a dangerous in-flight incident (e.g., limiting a descent rate can protect the operator from entering a vortex ring state).

In one embodiment, control laws used to enforce constraints (e.g., limits) on operation may include velocity limits (e.g., to prevent stalling in fixed-wing aircraft), acceleration limits, turning rate limits, engine power limits, rotor revolution per minute (RPM) limits, load power limits, allowable descent altitude limits, etc. Moreover, in some embodiments, the control laws module sets maneuver barriers for each vehicle to align with airframe aerodynamic limits, certification standards, and regulatory flight requirements such that some maneuvers (e.g., a barrel roll in a commercial helicopter platform) are not available to the operator in either the normal envelope state or the extended envelope state discussed below.

The control laws module instructs the actuators to maintain a last commanded altitude, forward speed, and level trim flight in all flight phases when no command is given. In this way, the control laws module reduces operator workload by implementing and displaying a visual representation of input the operator can make, e.g., through the stick inceptor device, gesture interface, or an automated control interface, while maintaining the vehicle inside the overall augmented stability and power available envelope. In the normal envelope state, there is no priority axis of command for power distribution. Therefore, to increase the controllable envelope in one axis, the operator must make an input to trade another flight parameter (e.g., reducing airspeed for an increased rate of climb or rate of turn).

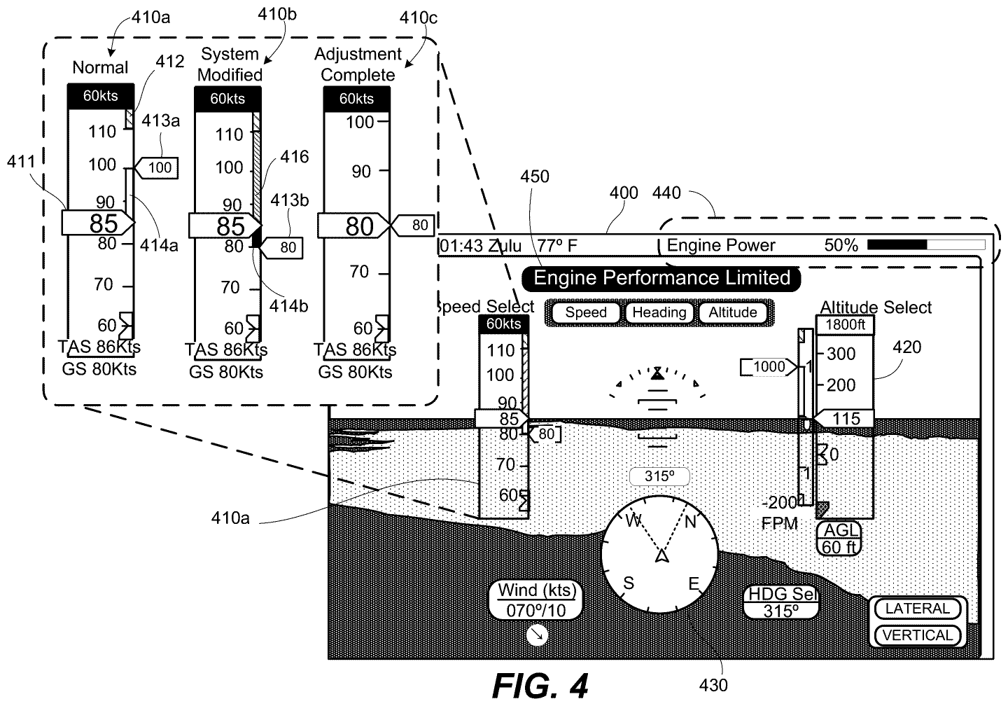

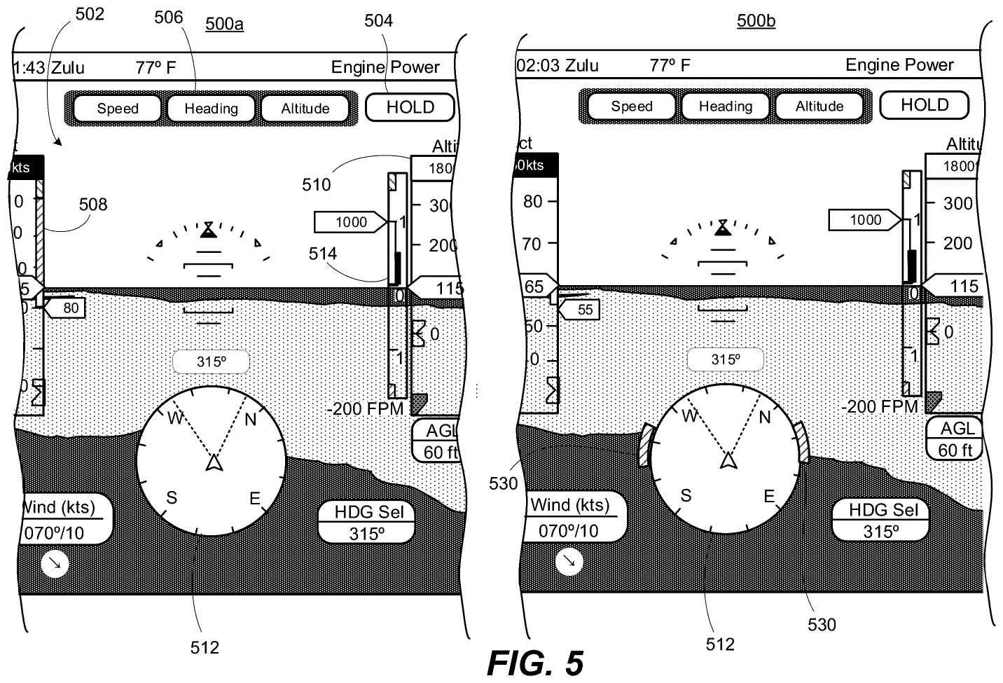

The dynamically calculated performance limits of the vehicle are displayed in each graphical flight instrument on the primary vehicle control interface. In one example, maximum or minimum allowable aircraft trajectory values are represented by rate limiting barber pole graphics on each graphical flight instrument, where grayed out portions of the instrument indicate to the operator upper or lower boundaries of a corresponding axis of movement. The range of values between the upper and lower limits therefore represents the flight envelope profile within which the vehicle may operate safely during the normal envelope state. As the values are dynamically adjusted during continued operation of the aircraft (e.g., in response to operator input through the universal vehicle control interfaces 210), the position of the upper or lower boundaries (e.g., the barber poles) is adjusted on the primary vehicle control interface. While the embodiment described herein contemplates use of barber pole visual indicators to display limits of the aircraft, one of skill in the art will recognize that other methods of displaying vehicle performance limitations (e.g., other graphical user interface elements) may be used in other embodiments. Example aircraft interfaces that may be displayed when the aircraft is operating in a normal envelope state are described in greater detail below with reference to FIGS. 4 and 5.

An extended envelope state is available that provides margins of increased control by temporarily allowing the operator to exceed performance limitations of the normal envelope state (e.g., when an emergency maneuver is required to avoid an unintended or potentially dangerous in-flight incident, such as a bird strike). In one embodiment, the operator causes the vehicle to enter the extended state via input to the stick inceptor device, such as a maximum rate plus maximum deflection of the stick inceptor device, to indicate to the control laws module to exceed operating limit for engine power of the vehicle and attempt to honor received command in the specified axes. In another embodiment, the operator causes the vehicle to enter the extended state through a mechanical controller movement at an acceleration exceeding a threshold acceleration. While the extended envelope state temporarily allows the aircraft to exceed the dynamically calculated maximum aircraft parameter values, in neither the normal nor the extended envelope state may ultimate aircraft parameter values be exceeded.

The control laws module generates the actuator commands to achieve the requested trajectory while attempting to maintain the vehicle as close as possible to the normal operating limitations (i.e., the maximum or minimum allowable aircraft trajectory values). The actuator commands can include instructions to modify navigation of the aerial vehicle (e.g., a speed modification, a lateral orientation modification, a heading modification, or a vertical position modification). To do so, the control laws module degrades aircraft parameters (e.g., airspeed, altitude, attitude, engine life) in a specified order, e.g., according to a hierarchy, in a manner that maintains baseline stability across the different axes of flight but executes on the operator's immediate intent. In some embodiments, a first set of aircraft parameters are degraded in a hierarchical order (e.g., rotor speed followed by torque followed by mean gas temperature), while a second set of aircraft parameters (e.g., altitude, speed, and turn limits) are not prioritized in a specified order but are maintained as close as possible to commanded input. The extended envelope enables the vehicle to temporarily operate within an extended set of parameter boundaries below ultimate threshold values (i.e., before the point at which vehicle safety is compromised).

In one embodiment, when the aircraft enters the extended envelope state, the digital interface generator 260 generates and provides for display (e.g., on the primary vehicle control interface) an advisory message or visual cue to indicate to the operator that the vehicle has reached a maximum allowable value of an aircraft parameter and that the vehicle has exited the normal flight envelope state. In some embodiments, the message might indicate to the operator one or more specific parameters that are being degraded to achieve the maximum value of the input parameter. The digital interface generator 260 may generate for display a status indicator that the aerial vehicle is operating in a degraded state. For example, the digital interface generator 260 may generate a visual cue that a particular parameter (e.g., airspeed) is being degraded.

Additionally or alternatively, an audio notification (an aural cue) is output, e.g., via one or more speakers of the aerial vehicle. For example, if the operator performs a maximum right turn deflection of the stick inceptor device (e.g., to avoid collision with a structure), the control laws module causes the vehicle to trade a first parameter (e.g., airspeed) followed by a second parameter (e.g., altitude) for maximum right turn rate availability, forcing the vehicle to perform a hard right turn. Visual or audio messages are output to the operator notifying the operator, for example, that the maximum turn rate has been reached, that normal flight envelope state has been exited, and, optionally, that the vehicle is degrading airspeed and altitude. The visual or audio cues may indicate a hierarchy or order in which aircraft parameters are being degraded (e.g., the audio cues list that, first, airspeed has been degraded, then second, that altitude has been degraded, then third, that engine life has been degraded, etc.).

The control laws module reestablishes normal envelope state functionality (e.g., after a hazard has been cleared) responsive to receiving additional operator input to the stick inceptor device, e.g., by re-centering the stick inceptor device for at least a threshold period of time to allow the actuators to return the vehicle to a baseline of level attitude, constant altitude, constant airspeed, and stable heading. In other embodiments, different operator input is used to trigger reengagement of normal flight envelope protection (e.g., via input to a gesture interface or an automated control interface). Responsive to reestablishing the normal state, the control laws module instructs the digital interface generator 260 to modify the primary vehicle control interface by removing the advisory message and, optionally, outputting a visual or audio notification to the operator, e.g., “Full Dynamic Flight Envelope Protection Restored.” Moreover, upon return to the normal state the digital interface generator 260 generates updated rate limiting barber pole graphics for display on each graphical flight instrument of the primary vehicle control interface.

The FAT voters 230 are configured to work together to determine which channels should be prevented from controlling the downstream functions, such as control of an actuator 215. Each FAT voter 230 comprises a channel enable logic configured to determine whether that channel should remain active. In response to a FAT voter 230 determining that its associated flight control computer 220 is malfunctioning during a self-assessment routine, the FAT voter 230 may disconnect the flight control computer 220 from the motors 240 in its channel, thus disconnecting the flight control computer 220 from all actuators 215. The self-assessment is performed in the processor of the flight control computer 220 based on high assurance software. The self-assessment routine assumes that the processor is in good working order. Each flight control computer 220 evaluates the signal output by the other channels to determine whether the other channels should be deactivated. Each flight control computer 220 compares the other flight control computers' 220 control commands to the downstream functions as well as other signals contained in the cross-channel data link to its own. Each flight control computer 220 may be connected to the other flight control computers 220 via a cross-channel data link. The flight control computer 220 executes a failure detection algorithm to determine the sanity of the other flight control computers 220. In response to other flight control computers 220 determining that a flight control computer 220 is malfunctioning, the FAT voter 230 for the malfunctioning flight control computer 220 may disconnect the malfunctioning flight control computer 220 from the motors 240 in its channel. In some embodiments, the FAT voter 230 may disconnect power to the malfunctioning flight control computer 220.

The backup power sources 235 are configured to provide power to the flight control computers 220 and motors 240 in the event of a disruption of power from a primary power source 250. The backup power source 235 may comprise a battery, an auxiliary generator, a flywheel, an ultra-cap, some other power source, or some combination thereof. The backup power source 235 may be rechargeable, but can alternately be a single use, or have any suitable cell chemistry (e.g., Li-ion, Ni-cadmium, lead-acid, alkaline, etc.). The backup power source is sufficiently sized to concurrently power all flight components necessary to provide aerial vehicle control authority and or sustain flight (e.g., alone or in conjunction with other backup power sources). The backup power source 235 may be sized to have sufficient energy capacity to enable a controlled landing, power the aerial vehicle for a at least a predetermined time period (e.g., 10 minutes, 20 minutes, 30 minutes, etc.), or some combination thereof. In some embodiments, the backup power source 235 can power the flight control computer 220, aerial vehicle sensors 245, and the motors 240 for the predetermined time period.

The backup power sources 235 can include any suitable connections. In some embodiments, each backup power source 235 may supply power to a single channel. In some embodiments, power can be supplied by a backup power source 235 over multiple channels, shared power connection with other backup power systems 235, or otherwise suitably connected. In some embodiments, the backup power sources 235 can be connected in series between the primary power source 250 and the flight control computer 220. In some embodiments, the backup power source 235 can be connected to the primary power source 250 during normal operation and selectively connected to the flight control computer 220 during satisfaction of a power failure condition. In some embodiments, the backup power source 235 can be connected in parallel with the primary power source 250. However, the backup power source can be otherwise suitably connected.

The backup power sources 235 may be maintained at substantially full state of charge (SoC) during normal flight (e.g., 100% SoC, SoC above a predetermined threshold charge), however can be otherwise suitably operated. In some embodiments, the backup power sources 235 draw power from the primary power source 250 during normal flight, may be pre-charged (or installed with a full charge) before flight initiation, or some combination thereof. The backup power sources 235 may employ load balancing to maintain a uniform charge distribution between backup power sources 235, which may maximize a duration of sustained, redundant power. Load balancing may occur during normal operation (e.g., before satisfaction of a power failure condition), such as while the batteries are drawing power from the primary power source 250, during discharge, or some combination thereof.

Backup power may be employed in response to satisfaction of a power failure condition. A power failure condition may include: failure to power the actuator from aerial vehicle power (e.g., main power source, secondary backup systems such as ram air turbines, etc.), electrical failure (e.g., electrical disconnection of UACR from primary power bus, power cable failure, blowing a fuse, etc.), primary power source 250 (e.g., generator, alternator, engine, etc.) failure, power connection failure to one or more flight components (e.g., actuators, processors, drivers, sensors, batteries, etc.), fuel depletion below a threshold (e.g., fuel level is substantially zero), some other suitable power failure condition, or some combination thereof. In some embodiments, a power failure condition can be satisfied by a manual input (e.g., indicating desired use of backup power, indicating a power failure or other electrical issue).

The motors 240A, 240B, 240C (collectively 240) are configured to move an actuator 215 to modify the position of an aerial vehicle component. Motors 240 may include rotary actuators (e.g., motor, servo, etc.), linear actuators (e.g., solenoids, solenoid valves, etc.), hydraulic actuators, pneumatic actuators, any other suitable motors, or some combination thereof. In some embodiments, an actuator 215 may comprise one motor 240 and associated electronics in each channel corresponding to each flight control computer 220. For example, the illustrated actuator 215 comprises three motors 240, each motor 240 associated with a respective flight control computer 220. In some embodiments, an actuator 215 may comprise a single motor 240 that comprises an input signal from each channel corresponding to each flight control computer 220. Each flight control computer 220 may be capable of controlling all actuators 215 by controlling all motors 240 within that channel.

The actuators 215 may be configured to manipulate control surfaces to affect aerodynamic forces on the aerial vehicle to execute flight control. The actuators 215 may be configured to replace manual control to components, include the power-plant, flaps, brakes, etc. In some embodiments, actuators 215 may comprise electromagnetic actuators (EMAs), hydraulic actuators, pneumatic actuators, any other suitable actuators, or some combination thereof. Actuators 215 may directly or indirectly manipulate control surfaces. Control surfaces may include rotary control surfaces (e.g., rotor blades), linear control surfaces, wing flaps, elevators, rudders, ailerons, any other suitable control surfaces, or some combination thereof. In some embodiments, actuators 215 can manipulate a swashplate (or linkages therein), blade pitch angle, rotor cyclic, elevator position, rudder position, aileron position, tail rotor RPM, any other suitable parameters, or some combination thereof. In some embodiments, actuators 215 may include devices configured to power primary rotor actuation about the rotor axis (e.g., in a helicopter).

The motors 240 may be electrically connected to any suitable number of backup power sources via the harness. The motors 240 can be connected to a single backup power source, subset of backup power sources, or each backup power source. In normal operation, each motor 240 in each channel may be powered by the flight control computer 220 in that channel. The motors 240 may be wired in any suitable combination/permutation of series/parallel to each unique power source in each channel. The motors 240 may be indirectly electrically connected to the primary power source 250 via the backup power source (e.g., with the backup power source connected in series between the motor 240 and primary power source 250), but can alternatively be directly electrically connected to the primary power source 250 (e.g., separate from, or the same as, that powering the backup power source). The flight control computer 220 in each channel independently powers and provides signals to each channel.

The various components may be connected by a harness, which functions to electrically connect various endpoints (e.g., modules, actuators, primary power sources, human machine interface, external sensors, etc.) on the aerial vehicle. The harness may include any suitable number of connections between any suitable endpoints. The harness may include a single (electrical) connector between the harness and each module, a plurality of connectors between each harness and each module, or some combination thereof. In some embodiments, the harness includes a primary power (e.g., power in) and a flight actuator connection (e.g., power out) to each module. In some embodiments, the harness can include separate power and data connections, but these can alternately be shared (e.g., common cable/connector) between various endpoints. The harness may comprise inter-module connections between each module and a remainder of the modules.

The harness may comprise intra-module electrical infrastructure (e.g., within the housing), inter-module connections, connections between modules and sensors (e.g., magnetometers, external air data sensors, GPS antenna, etc.), connections between modules and the human machine interface, or any other suitable connections. Intra-module connections can, in variants, have fewer protections (e.g., EMI protections, environmental, etc.) because they are contained within the housing. In variants, inter-module connections can enable voting between processors, sensor fusion, load balancing between backup power sources, or any other suitable power/data transfer between modules. In variants retrofitting an existing aerial vehicle or installed after-market, the harness can integrate with or operate in conjunction with (e.g., use a portion of) the existing aerial vehicle harness.

In some embodiments, the universal avionics control router 205 enables the aerial vehicle to operate in normal and degraded flight states based on sensor signal integrity. During a normal flight state, available in both hover-taxi and forward flight (i.e., below and above effective translational lift airspeeds, respectively), the universal avionics control router 205 uses an outer loop velocity-based fly-by-wire control logic that provides for lower operator workload and greater flight envelope protection capabilities. In one embodiment, operation in a normal flight state requires a GPS connection and an above-ground-level sensor that provides bottom-out protection for the aerial vehicle. Bottom-out protection may be enabled or disabled based on operator input or automatically (for example, when the vehicle reaches a specified airspeed, e.g., 30 knots)

Persistent inputs (e.g., via the stick inceptor device) include fore and aft (x-axis) speed commands, including zero-crossover protection. Non-persistent inputs include lateral (y-axis) turn rate commands during forward flight or translation commands during hover-taxi flight, altitude (z-axis) vertical speed commands, and twisting (ψ-axis) lateral trim acceleration commands during forward flight or rotation rate commands during hover-taxi phase. In one embodiment, release of the stick inceptor device returns the device to a zero-deflection state and causes the universal avionics control router 205 to return the aerial vehicle to a wings-level attitude, maintaining the last commanded altitude, and the last commanded fore and aft speed.

During pickup in a normal flight state, the operator deflects the stick inceptor device upward and returns the device back to a nominal position to increase the throttle from an idle state to a flight state. The available envelope for horizontal and vertical velocity is displayed (e.g., on the vehicle state display), enabling the operator to exercise finer control over the aerial vehicle. The commanded vertical speed may be increased within the envelope, and the operator may provide input to adjust pressure on different skids, cause one skid to lift before the other, counteract the effect of strong winds during a pickup or pickup from a slope. The universal avionics control router 205 stabilizes the vehicle system throughout pickup. In one embodiment, the operator provides the foregoing input in reverse to accomplish setdown. When the universal avionics control router 205 detects that the vehicle has returned to an “on-ground” state, the operator deflects the stick inceptor device downward and then returns the device to the nominal position to decrease the throttle from a flight state to the idle state. Moreover, in one embodiment, the universal avionics control router 205 enables auto-pickup and auto-setdown functionality to manipulate the throttle between the idle and flight states.

In some embodiments, the aerial vehicle is configured to operate in a degraded flight state when sensor signal (e.g., a GPS signal) or integrity is lost for more than a specified duration when the vehicle is operating in a hover-taxi phase. During the degraded flight state, the universal avionics control router 205 uses an inner loop acceleration-based fly-by-wire control logic, which results in a higher operator workload and less system protection than in the normal flight state. In one configuration, the degraded flight state is dictated by a hover trim position automatically set by the universal avionics control router 205 to maintain a centered or zero-deflection state of the stick inceptor device correlated to an appropriate center state attitude. When the hover trim position is set, the operator may use the stick inceptor device to control horizontal acceleration (tilting the rotor to affect a change in the thrust vector) from the hover trim position point. In one embodiment, the operator may provide input (e.g., via a long press of the hold button) to reset a current hover trim position to a new reference attitude (e.g., for the remainder of the flight).

The degraded flight state results in less system protection for the vehicle than the normal flight state. When the operator releases the stick inceptor device, the universal avionics control router 205 causes the vehicle to return to a stable hover and continue translating in the same direction until slowed by air resistance or until the operator makes an opposite input via the stick inceptor device to arrest the translation and bring the vehicle to a zeroed velocity. In one embodiment, the operator may choose to land the vehicle manually and disable the bottom-out protection, resulting in an increased operator workload. The universal avionics control router 205 may detect a return to normal operation of at least one sensor of an aerial vehicle, modify an operation of at least one of vehicle's actuators based on the detected return to normal operation, and update a GUI of the vehicle to display an indication that the vehicle is operating in a normal operating state. Maximum and minimum values for each axis of movement cannot be exceeded when the aerial vehicle is in the normal operating state.

As the operator commands horizontal acceleration with the stick inceptor device, the universal avionics control router 205 uses the above-ground-level sensor to automate collective control and maintain altitude (preventing dips during lateral accelerations and bounces during decelerations). If the above-ground-level sensor is lost, the operator commands vertical accelerations with the stick inceptor device to maintain altitude. Pitch and roll limits may be enforced to limit the rate of acceleration. However, in one embodiment, the universal avionics control router 205 cannot limit velocities.

The degraded flight state allows the operator to perform precision pickups (i.e., bringing an aerial vehicle from ground to a hovering position), setdowns (i.e., bringing an aerial vehicle from a hovering position to ground), and hover taxi without a GPS sensor input by creating a more direct link between the position of the stick inceptor device and the angle of the rotor system. More operator input is required to counteract horizontal and vertical drift than in the normal flight state, therefore the vehicle makes the inceptor system less reactive to avoid sudden changes in velocity due to over-controlled operator inceptor inputs. For example, the universal avionics control router 205 may enforce pitch and roll limits, reducing the inceptor system's reaction to a certain range of operator control in those axes, to avoid the sudden changes in velocity.

In one embodiment, the operator can manually set the hover trim position by deflecting the stick inceptor device and providing input via the vehicle state display. For example, the operator can set the hover trim position by pressing and holding a specified key or icon on the display for more than a threshold period of time (e.g., greater than eight seconds). This action allows the operator to reset the hover trim position to a desired state. When sensor signal (e.g., a GPS signal) or integrity is regained, the universal avionics control router 205 prompts the pilot (e.g., via the vehicle state display) that normal flight state is available and can be reinitiated at the pilot's discretion.

### Example Vehicle Control Interfaces and Hold Functionality

FIG. 3 illustrates one example embodiment of a configuration 300 for a set of universal vehicle control interfaces in a vehicle. The vehicle control interfaces in the configuration 300 may be embodiments of the universal vehicle control interfaces 110, as described above with reference to FIG. 1. In the embodiment shown, the configuration 300 includes a vehicle state display 310, a side-stick inceptor device (also referred to as a mechanical controller) 340, and a vehicle operator field of view 350. In other embodiments, the configuration 300 may include different or additional elements. Furthermore, the functionality may be distributed among the elements in a different manner than described.

The vehicle state display 310 is one or more electronic displays (e.g., liquid-crystal displays (LCDs) configured to display or receive information describing a state of the vehicle including the configuration 300. In particular, the vehicle state display 310 may display various interfaces including feedback information for an operator of the vehicle. In this case, the vehicle state display 310 may provide feedback information to the operator in the form of virtual maps, 3D terrain visualizations (e.g., wireframe, rendering, environment skin, etc.), traffic, weather, engine status, sensor status, communication data (e.g., air traffic control (ATC) communication), guidance information (e.g., guidance parameters, trajectory), notifications of degraded flight state, sensor loss, degradation of one or more aircraft parameters, and any other pertinent information. Additionally, or alternatively, the vehicle state display 310 may display various interfaces for configuring or executing automated vehicle control processes, such as automated aircraft landing or takeoff or navigation to a target location. The vehicle state display 310 may receive user inputs via various mechanisms, such as gesture inputs, audio inputs, or any other suitable input mechanism.

As depicted in FIG. 3 the vehicle state display 310 includes a primary vehicle control interface 320 and a multi-function interface 330. The primary vehicle control interface 320 is configured to facilitate short-term control of the vehicle including the configuration 300. In particular, the primary vehicle control interface 320 includes information immediately relevant to control of the vehicle, such as current universal control input values or a current state of the vehicle. As an example, the primary vehicle control interface 320 may include a virtual object representing the vehicle in 3D or 2D space. In this case, the primary vehicle control interface 320 may adjust the display of the virtual object responsive to operations performed by the vehicle in order to provide an operator of the vehicle with visual feedback. The primary vehicle control interface 320 may additionally, or alternatively, receive universal vehicle control inputs via gesture inputs.

The multi-function interface 330 is configured to facilitate long-term control of the vehicle including the configuration 300. In particular, the primary vehicle control interface 320 may include information describing a mission for the vehicle (e.g., navigation to a target destination) or information describing the vehicle systems. Information describing the mission may include routing information, mapping information, or other suitable information. Information describing the vehicle systems may include engine health status, engine power utilization, sensor states, fuel, lights, vehicle environment, degradation of specific parameters, or other suitable information. In some embodiments, the multi-function interface 330 or other interfaces enable mission planning for operation of a vehicle. For example, the multi-function interface 330 may enable configuring missions for navigating a vehicle from a start location to a target location. In some cases, the multi-function interface 330 or another interface provides access to a marketplace of applications and services. The multi-function interface 330 may also include a map, a radio tuner, or a variety of other controls and system functions for the vehicle.

In some embodiments, the vehicle state display 310 includes information describing a current state of the vehicle relative to one or more control limits of the vehicle (e.g., on the primary vehicle control interface 320 or the multi-function interface 330). For example, the information may describe power limits of the vehicle or include information indicating how much control authority a use has across each axis of movement for the vehicle (e.g., available speed, turning ability, climb or descent ability for an aircraft, etc.). In the same or different example embodiment, the vehicle state display 310 may display different information depending on a level of experience of a human operator of the vehicle. For instance, if the vehicle is an aircraft and the human operator is new to flying, the vehicle state display may include information indicating a difficulty rating for available flight paths (e.g., beginner, intermediate, or expert). The particular experience level determined for an operator may be based upon prior data collected and analyzed about the human operator corresponding to their prior experiences in flying with flight paths having similar expected parameters. Additionally, or alternatively, flight path difficulty ratings for available flight paths provided to the human operator may be determined based on various information, for example, expected traffic, terrain fluctuations, airspace traffic and traffic type, how many airspaces and air traffic controllers along the way, or various other factors or variables that are projected for a particular flight path. Moreover, the data collected from execution of this flight path can be fed back into the database and applied to a machine learning model to generate additional or refined ratings data for the operator for subsequent application to other flight paths. Vehicle operations may further be filtered according to which one is the fastest, the most fuel efficient, or the most scenic, etc.

The one or more vehicle state displays 310 may include one or more electronic displays (e.g., liquid-crystal displays (LCDs), organic light emitting diodes (OLED), plasma). For example, the vehicle state display 310 may include a first electronic display for the primary vehicle control interface 320 and a second electronic display for the multi-function interface 330. In cases where the vehicle state display 310 include multiple electronic displays, the vehicle state display 310 may be configured to adjust interfaces displayed using the multiple electronic displays, e.g., in response to failure of one of the electronic displays. For example, if an electronic display rendering the primary vehicle control interface 320 fails, the vehicle state display 310 may display some or all of the primary vehicle control interface 320 on another electronic display.

The one or more electronic displays of the vehicle state display 310 may be touch sensitive displays is configured to receive touch inputs from an operator of the vehicle including the configuration 300, such as a multi-touch display. For instance, the primary vehicle control interface 320 may be a gesture interface configured to receive universal vehicle control inputs for controlling the vehicle including the configuration 300 via touch gesture inputs. In some cases, the one or more electronic displays may receive inputs via other type of gestures, such as gestures received via an optical mouse, roller wheel, three-dimensional (3D) mouse, motion tracking device (e.g., optical tracking), or any other suitable device for receiving gesture inputs.

Touch gesture inputs received by one or more electronic displays of the vehicle state display 310 may include single finger gestures (e.g., executing a predetermined pattern, swipe, slide, etc.), multi-finger gestures (e.g., 2, 3, 4, 5 fingers, but also palm, multi-hand, including/excluding thumb, etc.; same or different motion as single finger gestures), pattern gestures (e.g., circle, twist, convergence, divergence, multi-finger bifurcating swipe, etc.), or any other suitable gesture inputs. Gesture inputs can be limited asynchronous inputs (e.g., single input at a time) or can allow for multiple concurrent or synchronous inputs. In variants, gesture input axes can be fully decoupled or independent. In a specific example, requesting a speed change holds other universal vehicle control input parameters fixed—where vehicle control can be automatically adjusted in order to implement the speed change while holding heading and vertical rate fixed. Alternatively, gesture axes can include one or more mutual dependencies with other control axes. Unlike conventional vehicle control systems, such as aircraft control systems, the gesture input configuration as disclosed provides for more intuitive user experiences with respect to an interface to control vehicle movement.

In one embodiment, a universal avionics control router, such as the universal avionics control router 205, enables an operator to activate a digital touch control system hold function that latches all input control axes (Y-axis, y-axis, Z-axis) and holds in the commanded rate without the need for constant deflection of a hardware input device, such as the side-stick inceptor device 340. The hold function on/off command is controlled via user input to the touch-sensitive display of the multi-function interface 330. Responsive to receiving user input to initiate a hold, the universal vehicle control router 205 recognizes the commanded rate for each control axis and converts the user input to a suitable set of hold commands for actuators of the vehicle. When the hold function is active, an operator of the aircraft can make small adjustments to the command via the touch-sensitive display, adjusting a commanded rate up or down, e.g., via a drag gesture or other input to the multi-function interface 330.

In one embodiment, if the operator deflects the side-stick inceptor device 340, only the specifically deflected axis releases hold, while inputs to the other axes remain at the commanded hold rates. Conversely, if the operator centers the side-stick inceptor device 340 and provides input via the multi-function interface 330 to release the hold, all axes holds are canceled. When the hold is canceled, the universal vehicle control router 205 provides commands to the actuators to return the vehicle to the last commanded velocity and a current heading.

The hold function may be used to establish an orbit of the vehicle relative to an object, such as a car. To do so, the operator inputs a Y-axis hold, e.g., via deflection of the side-stick inceptor device 340 and input to the multi-function interface 330, causing the vehicle to travel in a circle. In one embodiment, the operator can provide additional input via twist of the side-stick inceptor device 340 or touch input to the multi-function interface 330 to point the nose of the vehicle towards a point of reference at the center of the orbit. During the orbit, the universal vehicle control router 205 monitors aircraft parameter limitation values, e.g., for aircraft efficiency, safety, etc. For example, a maximum twist might be imposed to prevent the aircraft from spinning, minimize a loss of tail rotor effectiveness, etc.

In some embodiments, the vehicle state display 320 or other interfaces are configured to adjust in response to vehicle operation events, such as emergency conditions. For instance, in response to determining the vehicle is in an emergency condition, the vehicle control and interface system 100 may adjust the vehicle state display 310 to include essential information or remove irrelevant information. As an example, if the vehicle is an aircraft and the vehicle control and interface system 100 detects an engine failure for the aircraft, the vehicle control and interface system 100 may display essential information on the vehicle state display 310 including 1) a direction of the wind, 2) an available glide range for the aircraft (e.g., a distance that the aircraft can glide given current conditions), or 3) available emergency landing spots within the glide range. The vehicle control and interface system 100 may identify emergency landing locations using various processes, such as by accessing a database of landing spots (e.g., included in the data store 150 or a remote database) or ranking landing spots according to their suitability for an emergency landing. Example configurations of the vehicle state display when the vehicle is operating in an extended dynamic flight envelope state and a degraded flight state are described in greater detail below with respect to FIGS. 4 and 5.

The side-stick inceptor device 340 may be a side-stick inceptor configured to receive universal vehicle control inputs. In particular, the side-stick inceptor device 340 may be configured to receive the same or similar universal vehicle control inputs as a gesture interface of the vehicle state display 310 is configured to receive. In this case, the gesture interface and the side-stick inceptor device 340 may provide redundant or semi-redundant interfaces to a human operator for providing universal vehicle control inputs. The side-stick inceptor device 340 may be active or passive. Additionally, the side-stick inceptor device 340 and may include force feedback mechanisms along any suitable axis. For instance, the side-stick inceptor device 340 may be a 3-axis inceptor, 4-axis inceptor (e.g., with a thumb wheel), or any other suitable inceptor.

The components of the configuration 300 may be integrated with the vehicle including the configuration 300 using various mechanical or electrical components. These components may enable adjustment of one or more interfaces of the configuration 300 for operation by a human operator of the vehicle. For example, these components may enable rotation or translation of the vehicle state display 310 toward or away from a position of the human operator (e.g., a seat where the human operator sits). Such adjustment may be intended, for example, to prevent the interfaces of the configuration 300 from obscuring a line of sight of the human operator to the vehicle operator field of view 350.

The vehicle operator field of view 350 is a first-person field of view of the human operator of the vehicle including the configuration 300. For example, the vehicle operator field of view 350 may be a windshield of the vehicle or other suitable device for enabling a first-person view for a human operator.

The configuration 300 additionally or alternately include other auxiliary feedback mechanisms, which can be auditory (e.g., alarms, buzzers, etc.), haptic (e.g., shakers, haptic alert mechanisms, etc.), visual (e.g., lights, display cues, etc.), or any other suitable feedback components. Furthermore, displays of the configuration 300 (e.g., the vehicle state display 310) can simultaneously or asynchronously function as one or more of different types of interfaces, such as an interface for receiving vehicle control inputs, an interface for displaying navigation information, an interface for providing alerts or notifications to an operator of the vehicle or any other suitable vehicle instrumentation. Furthermore, portions of the information can be shared between multiple displays or configurable between multiple displays.

### Example Vehicle State Displays

FIG. 4 illustrates one example embodiment of an aircraft interface 400 of an aerial vehicle operating in a degraded state. The interface 400 may be an embodiment of a universal vehicle control interface 110 provided by the vehicle control and interface system 100. For example, the aircraft interface 400 may be an embodiment of an interface displayed by the vehicle state display 310, such as the multi-function interface 320 or the primary vehicle control interface 320. In other cases, the aircraft interface 400 may be provided for display on a virtual reality (VR) or augmented reality (AR) headset, overlaying a portion of the windshield of an aircraft, or any other suitable display mechanism.

The interface 400 includes a speed element. The speed element of the interface 400 is shown in three views, speed elements 410a, 410b, and 410c, but may collectively be referred to as the speed element 410. The interface 400 further includes an altitude element 420, a heading element 430, an engine power element 440, and a visual cue 450 to indicate to the operator that the vehicle is operating in a degraded state. The visual cue 450 is an engine power indicator.

The vehicle control and interface system 100 can dynamically calculate a maximum or minimum aircraft trajectory value for one or more axis of control based on an aircraft parameter of the aerial vehicle. For example, the vehicle control and interface system 100 monitors the aircraft parameter of engine power and automatically modifies the airspeed responsive to the engine power declining below a minimum engine power. The vehicle control and interface system 100, during operation of the aerial vehicle at an engine power below a threshold power value, detects a failure of the engine of the aerial vehicle for at least a threshold period of time (e.g., eight seconds). The vehicle control and interface system 100 can update a GUI displaying the modified airspeed as the vehicle control and interface system 100 is calculating new minimum or maximum airspeed values. In this way, the operator has more context cues for the aerial vehicle's operational limits as they are operating the vehicle.

The speed element 410a is a first view of the speed element 410 in a normal operating state. In this normal operating state, the aerial vehicle cannot exceed the maximum and minimum values for the airspeed depicted on the speed element 410a (e.g., as indicated by barber pole 412). The speed element 410b is a second view of the speed element 410 in a state pending modification by the vehicle control and interface system 100. The speed element 410c is a third view of the speed element 410 in an adjusted state, where the vehicle control and interface system 100 has finished adjusting the airspeed that can be controlled using the speed element 410.

The speed element includes a current value indicator 411 indicating the current airspeed of the vehicle. The speed element 410 includes a barber pole 412 indicating a range of values that represent an upper or lower limit to the airspeed. Although the barber pole 412 depicts an upper range of maximum airspeeds that the operator can engage in, the interface 400 may also display a barber pole depicting a range of minimum airspeeds that the operator can engage in. The speed element 410a includes a command input indicator 413a indicating a target airspeed that the operator has commanded the aerial vehicle to achieve. The speed element 410a includes a modification bar 414a indicating a difference in airspeed values that the aerial vehicle needs to adjust to achieve the target airspeed. The vehicle control and interface system 100 may determine to modify the flight protection envelope(s) (e.g., decrease the target airspeed) in response to the status of an operating parameter of the aerial vehicle (e.g., the engine power). For example, the vehicle control and interface system 100 determines to decrease the target airspeed from 100 KTS to 80 KTS in response to the engine power being below a minimum engine power (e.g., 50%). Although the interface 400 depicts engine power, the vehicle control and interface system 100 may generate any suitable indicator related to engine power (e.g., amount of torque available for the vehicle to drive, the temperature of the engine, etc.) or a combination of engine power indicators.

The speed element 410b includes a barber pole 416 indicating a conditionally applied maximum range of airspeeds by the vehicle control and interface system 100. The vehicle control and interface system 100 may remove the barber pole 416 for display once a condition has been met (e.g., once an adjustment to a target airspeed has been achieved as shown in the display of the speed element 410c). The speed element 410b includes a command input indicator 413b that reflects a new target airspeed of 80 KTS. The modification bar 414b is generated for display in a manner different from the modification bar 414a (e.g., a different shading or color) to indicate a difference between the source of the commanded airspeed. In some embodiments, the difference in how the differential bar is displayed indicates whether the modification to airspeed is from the operator or automatically determined by the vehicle control and interface system 100. The speed element 410c depicts the completed modification by the vehicle control and interface system 100 where the current speed is now 80 KTS.

FIG. 5 illustrates one example embodiment of an interface for an aerial vehicle in a normal dynamic flight envelope protection range. The aircraft interface is shown in two views, interfaces 500a and 500b, but may collectively be referred to as the interface 500. The interface 500a is a first view of the interface 500 for the aerial vehicle during forward flight (i.e., when the vehicle is operating at above a specified airspeed, e.g., an effective translational lift (ETL) speed). The interface 500b is a second view of the interface 500 for the aerial vehicle during a hover-taxi phase of flight (i.e., when the vehicle is operating at below a specified airspeed, e.g., an ETL airspeed).

The interface 500 may be an embodiment of a universal vehicle control interface 110 provided by the vehicle control and interface system 100. For example, the aircraft interface 500 may be an embodiment of an interface displayed by the vehicle state display 310, such as the multi-function interface 320 or the primary vehicle control interface 320. In other cases, the aircraft interface 500 may be provided for display on a virtual reality (VR) or augmented reality (AR) headset, overlaying a portion of the windshield of an aircraft, or any other suitable display mechanism.

The interface 500 includes an environment display 502 that represents a physical environment in which the vehicle is operating. As depicted in FIG. 5, the environment display 502 includes a rendering of various environmental features, for example, the position of a horizon line separating the sky and ground plane, a position of the sun or clouds, locations of buildings or other structures, and the like. The features of the environment display 502 may be virtually rendered using various techniques, such as using virtual objects, augmented reality (e.g., map or satellite images), or some combination thereof. In some embodiments, the environment display 502 is augmented with virtual objects to convey various information to a human operator of the aircraft. For example, the interface 500 can include a forecasted flightpath for the physical aircraft or a set of navigational targets delineating a flight path for the physical aircraft. Moreover, in some embodiments, the interface 500 includes a visualization of a virtual aircraft object representative of a state of a physical aircraft.

The vehicle control and interface system 100 generates the environment display 502 based on a computer vision pose of the physical aircraft (e.g., of the current aircraft conditions, global aircraft position or orientation). The pose can be determined based on GPS, odometry, trilateration from ground fiducials (e.g., wireless fiducials, radar fiducials, etc.), or other signals. The vehicle control and interface system 100 may generate the environment display 502 from suitable terrain database, map, imaging or other sensor data generated by the physical aircraft, or other suitable data. As an example, the vehicle control and interface system 100 may select a map segment using the aircraft pose, determine an augmented field of view or perspective, determine augmented target placement, determine pertinent information (e.g., glideslope angle), determine a type of virtual environment (e.g., map vs rendering), or any other suitable information based on the pose of the physical aircraft. The environment display 502 can be pre-rendered, rendered in real time (e.g., by z-buffer triangle rasterization), dynamically rendered, not rendered (e.g., 2D projected image, skin, etc.) or otherwise suitably generated relative to the view perspective.

The aircraft interface 500 further includes a set of interface elements overlaying the environment display 502. The interface elements include an aircraft control interface selection elements 506, a speed element 508, an altitude element 510, a heading element 512, and a climb rate gauge 514. Barber poles 530 surrounding the heading element 512 may appear when the aerial vehicle is in a hover-taxi phase. The barber poles 530 can reflect a maximum yaw rate (i.e., turn rate).

The speed element 508, altitude element 510, and heading element 512 each include information indicating a current aircraft control input value and information indicating a respective value for a current state of the aircraft. For example, the speed element 508 can include a vertical bar indicating a possible forward speed input value range from 50 knots (KTS) to 115 knots, with a current forward speed input value of 85 KTS, and a current command input of 80 KTS (e.g., based on operator input via a mechanical controller, auto flight input, touch input, or other means used to generate a command). The speed element 508 can also include a True Airspeed (TAS) indicator and a ground speed indicator.

Similarly, the altitude element 510 can include a vertical bar indicating a possible altitude value range (e.g., from 1350 feet to 2000 feet), a current altitude value (e.g., 115 feet), a barometric pressure (e.g., 29.92 Hg), and a ground clearance (e.g., 60 ft).

The heading element 512 includes a virtual compass indicating a possible heading input value range. The climb rate gauge 514 includes a vertical bar indicating a possible climb rate of the aerial vehicle from current 680 feet per minute (fpm) to commanded 750 fpm with a maximum climb rate is 1500 fpm. As discussed above, maximum aircraft parameter values, including the maximum climb rate, are dynamically calculated and may be based on current values of other parameters, such as the vehicle's forward speed and altitude. Additionally, one or more GUI elements may be used to visually indicate a difference between current and commanded input values. For example, in the displayed embodiment, a first vertical bar and arrow reflect the commanded climb rate of 1000 fpm while a second, adjacent vertical bar reflects the current climb rate of 500 fpm, indicating that the aerial vehicle has not yet reached the commanded climb rate. The climb rate gauge 514 also displays maximum and minimum achievable climb rates in the forward phase of flight, as indicated by the barber poles at the top and bottom of the climb rate gauge 514.

In the embodiment shown in FIG. 5, the vehicle is operating in a normal dynamic flight envelope state, in which the outer processing loop of the control laws module dynamically calculates maximum or minimum allowable aircraft trajectory values for each axis of control and displays the performance limits in the graphical flight instruments on the primary vehicle control interface. For example, each of the speed element 508, altitude element 510, and climb rate gauge 514 include rate limiting barber pole graphics indicating minimum or maximum allowable values for the corresponding aircraft trajectory parameter. These ranges of allowable values for the axes of movement are dynamically adjusted during operation of the aerial vehicle.

The aircraft control interface selection element 506 facilitates selection of an aircraft control interface from a set of multiple aircraft control interfaces. In particular, the aircraft control interfaces that can be selected from the element 506 include a forward speed macro for receiving a requested aircraft forward speed (as indicated by the “Speed” interface element), a heading macro for receiving a requested aircraft heading (as indicated by the “Heading” interface element), and an altitude macro for receiving a requested aircraft altitude (as indicated by the “Altitude” interface element). As an example, a user of the aircraft interface 500 may select from the set of aircraft control interfaces via touch inputs (e.g., taps) on the respective interface elements to provide information describing a requested aircraft state, such as a requested forward velocity, a requested heading, or a requested altitude. In one embodiment, the aircraft control interface selection element 506 also includes a selectable hold element 504, which, when engaged, causes the vehicle to hold commanded rates of each axis, as discussed above with respect to FIG. 3. The operator can select the hold element 504 again to disengage the multi-axis hold.

### Example Processes for Dynamic Flight Envelope Protection and Degraded Flight State Operation

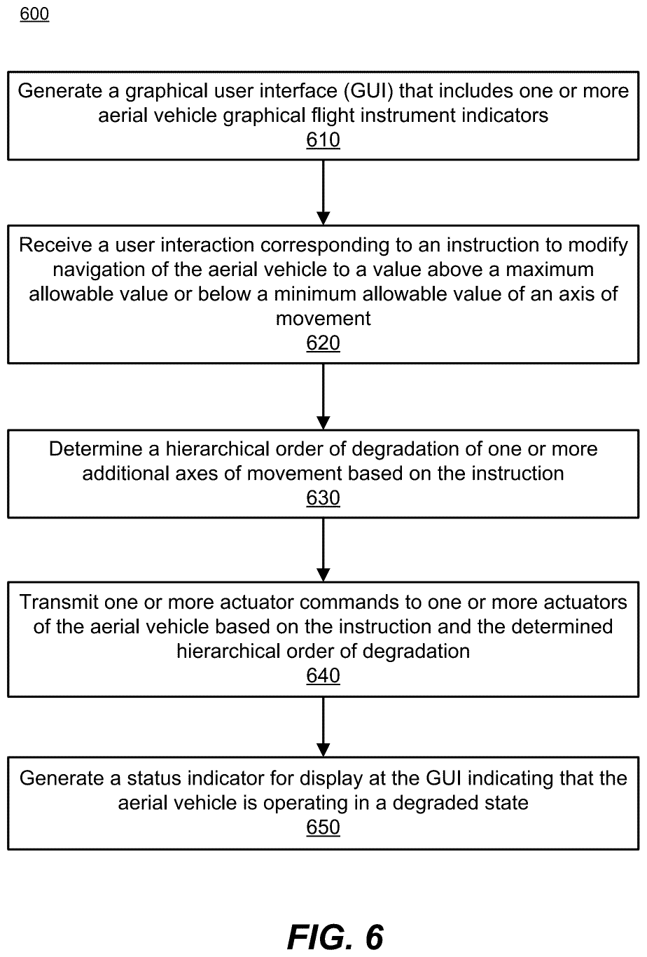

FIG. 6 is a flowchart of a process 600 for modifying a GUI based on degraded axis movement of an aerial vehicle, in accordance with one embodiment. The process 600 may be performed by the vehicle control and interface system 100. The process 600 may have additional, fewer, or different operations.

The vehicle control and interface system 100 generates 610 a GUI that includes one or more aerial vehicle graphical flight instrument indicators. The interfaces shown in FIGS. 4 and 5 include example aerial vehicle graphical flight instrument indicators such as the speed element 410 or the speed element 508. A flight instrument indicator may be displayed with visual elements indicating possible ranges of values that the aerial vehicle can operate in within an axis of movement corresponding to the flight instrument indicator. For example, barber poles on an airspeed flight instrument indicator reflect an upper range of maximum airspeeds and a lower range of minimum airspeeds.

The vehicle control and interface system 100 receives 620 a user interaction corresponding to an instruction to modify navigation of the aerial vehicle to a value above a maximum allowable value or below a minimum allowable value of an axis of movement. For example, the user interaction can include maximum deflection of a mechanical controller through which the aerial vehicle is controlled. In another example, the user interaction can be a mechanical controller movement at an acceleration exceeding a threshold acceleration.

The vehicle control and interface system 100 determines 630 a hierarchical order of degradation of one or more additional axes of movement based on the instruction. For example, if the instruction is to increase the turn rate of the aerial vehicle beyond a maximum turn rate, the vehicle control and interface system 100 applies rules-based determination that the first axis of movement to be degraded is airspeed. In another example, the vehicle control and interface system 100 can determine which axis of movement to degrade based on an order in which instructions were received. For example, the operator provides commands to increase airspeed, increase climb rate, and increase turn rate in that order. The vehicle control and interface system 100 may degrade, based on that order, airspeed first and climb rate second in order to accommodate the operator's latest request to increase turn rate.

The vehicle control and interface system 100 transmits 640 one or more actuator commands to one or more actuators of the aerial vehicle based on the instruction and the determined hierarchical order of degradation. For example, the vehicle control and interface system 100 may transmit instructions to an actuator to increase the airspeed of the aerial vehicle based on an instruction to increase climb rate of the aerial vehicle.

The vehicle control and interface system 100 generates 650 a status indicator for display at the GUI indicating that the aerial vehicle is operating in a degraded state. For example, as shown in FIG. 4, the vehicle control and interface system 100 generated a modification bar in a different visual style (e.g., different shading or color) to indicate that the system 100 was automatically making the adjustment to degrade the airspeed (i.e., to accommodate for the declining engine power level). FIG. 4 also shows a status indicator that the aerial vehicle is operating with low engine power.

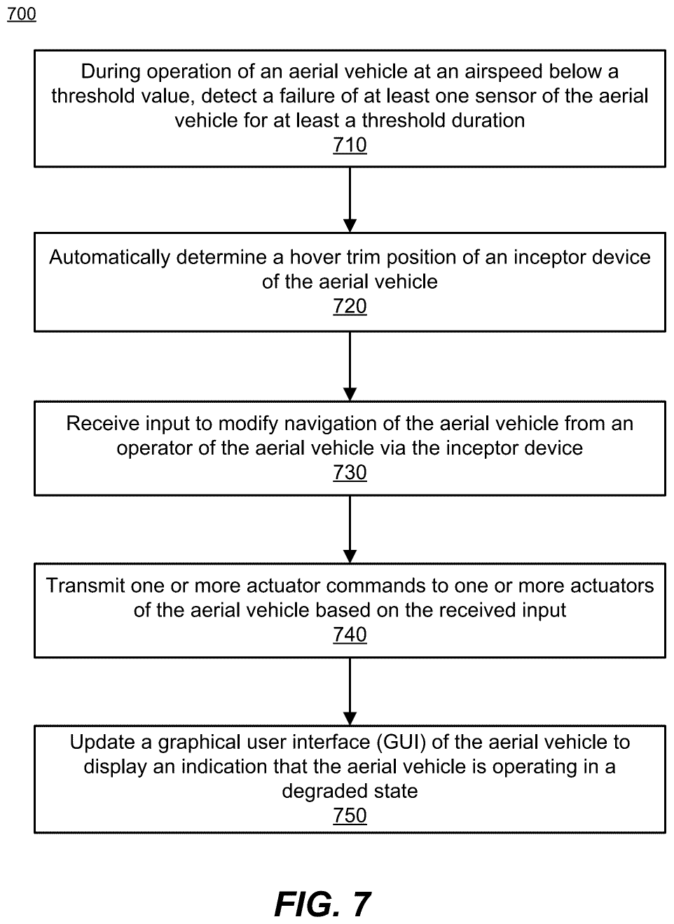

FIG. 7 is a flowchart of a process 700 for modifying a navigation and a GUI of an aerial vehicle responsive to the aerial vehicle operating in a degraded state, in accordance with one embodiment. The process 700 may be performed by the vehicle control and interface system 100. The process 700 may have additional, fewer, or different operations. For example, the vehicle control and interface system 100 may, responsive to detection of a release of the mechanical controller, modify the operation of at least one of the one or more actuators to return an aerial vehicle to a stable hover after the vehicle was operating in a degraded state.

The vehicle control and interface system 100 detects 710, during operation of an aerial vehicle at an airspeed below a threshold value, a failure of at least one sensor of the aerial vehicle for at least a threshold duration. For example, the system 100 detects 710 an invalid GPS position or a lack of GPS signal for more than ten seconds. The threshold value can include an effective translational lift airspeed. The aerial vehicle can operate in a hover-taxi phase when the airspeed is below the effective translational lift.

The vehicle control and interface system 100 determines 720, automatically, a hover trim position of an inceptor device of the aerial vehicle. The hover trim position can be set to maintain a center state of the inceptor device with an appropriate center state of a vehicle attitude. Once the hover trim position is set, the operator may use the inceptor device to control horizontal acceleration of the vehicle. The operator may maintain a hover position and a forward or lateral speed while the vehicle control and interface system 100 may maintain an attitude of the vehicle (e.g., by an above ground level (AGL) sensor). If an AGL sensor reading is lost as the attitude is automatically maintained, the operator can use the inceptor device (e.g., a vertical thumb lever) to maintain the attitude. The vehicle control and interface system 100 may automatically enforce pitch and roll limits to limit the rate of acceleration and lower the probability that a sudden change in velocity occurs and endangers the operator.

The vehicle control and interface system 100 receives 730 an input to modify navigation of the aerial vehicle from an operator of the aerial vehicle via the inceptor device. The vehicle control and interface system 100 transmits 740 one or more actuator commands to one or more actuators of the aerial vehicle based on the received input. The vehicle control and interface system 100 updates 750 a GUI of the aerial vehicle to display an indication that the aerial vehicle is operating in a degraded state.

The vehicle control and interface system 100 may further detect a return to normal operation of the at least one sensor of the aerial vehicle after operating the vehicle in a degraded state. The vehicle control and interface system 100 can modify an operation of at least one of the one or more actuators based on the detected return to normal operation. The vehicle control and interface system 100 may update the GUI of the aerial vehicle to display an indication that the aerial vehicle is operating in a normal operating state. The vehicle control and interface system 100 may be configured to operate the aerial vehicle in a normal operating state when the airspeed meets the threshold value and GPS is available

### Computing Machine Architecture

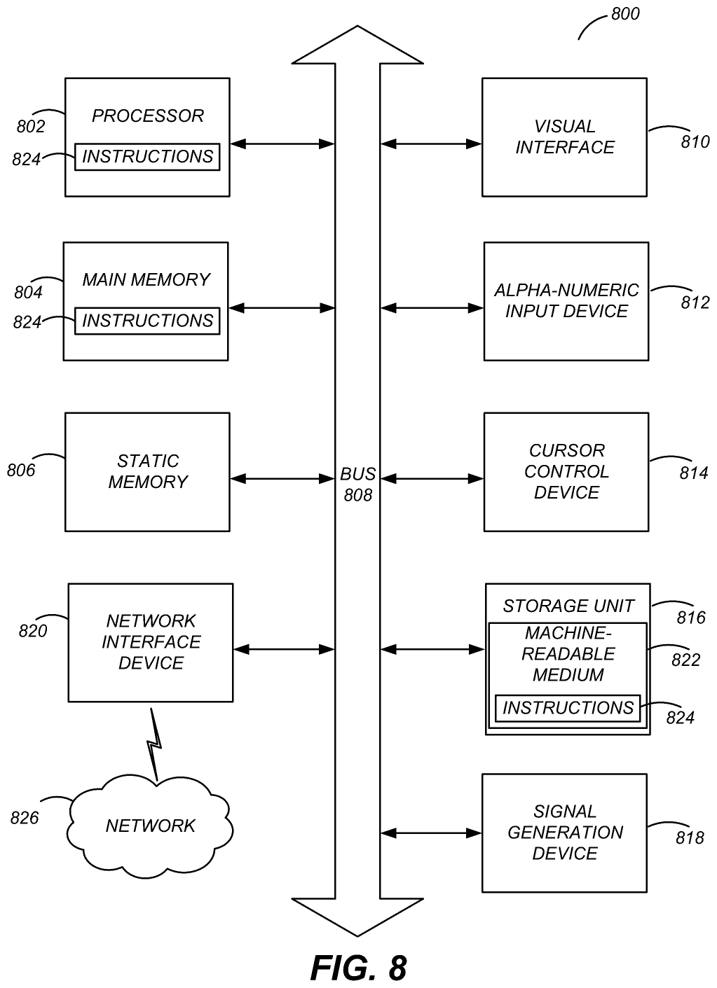

FIG. 8 is a block diagram illustrating one embodiment of components of an example machine able to read instructions from a machine-readable medium and execute them in a processor (or controller). Specifically, FIG. 8 shows a diagrammatic representation of a machine in the example form of a computer system 800 within which program code (e.g., software) for causing the machine to perform any one or more of the methodologies discussed herein may be executed. The computer system 800 may be used for one or more components of the vehicle control and interface system 100 depicted and described through FIGS. 1-7. The program code may be comprised of instructions 824 executable by one or more processors 802. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a computing system capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes one or more processors 802 (e.g., a central processing unit (CPU), a graphics processing unit (GPU), a digital signal processor (DSP), one or more application specific integrated circuits (ASICs), one or more radio-frequency integrated circuits (RFICs), field programmable gate arrays (FPGAs)), a main memory 804, and a static memory 806, which are configured to communicate with each other via a bus 808. The computer system 800 may further include visual display interface 810. The visual interface may include a software driver that enables (or provide) user interfaces to render on a screen either directly or indirectly. The visual interface 810 may interface with a touch enabled screen. The computer system 800 may also include input devices 812 (e.g., a keyboard), a cursor control device 814 (e.g., a mouse), a storage unit 816, a signal generation device 818 (e.g., a microphone or speaker), and a network interface device 820, which also are configured to communicate via the bus 808. The network interface device 820 is configured to communicate with a network 826.

The storage unit 816 includes a machine-readable medium 822 (e.g., magnetic disk or solid-state memory) on which is stored instructions 824 (e.g., software) embodying any one or more of the methodologies or functions described herein. The instructions 824 (e.g., software) may also reside, completely or at least partially, within the main memory 804 or within the processor 802 (e.g., within a processor's cache memory) during execution.

### Additional Configuration Considerations

The disclosed systems may increase vehicle safety by providing a full fly-by-wire (FBW) architecture with a redundant architecture. For example, the FBW architecture may comprise triple redundancy, quadruple redundancy, or any other suitable level of redundancy. The systems may enable retrofitting an existing vehicle with an autonomous agent (or enable autonomous agent certification) by providing a sufficient degree of control and power redundancy to autonomous agents.

The disclosed systems may enable autonomous or augmented control schemes without relying on the pilot (or other operator) as a backup in the event of power failure. Accordingly, such systems may fully eliminate the ‘direct human control’ layer because augmented modes are persistent in the event of multiple power failures (e.g., augmented control modes can rely on triply-redundant, continuous backup power). Such systems may allow transportation providers and users to train in only a normal mode, thereby decreasing or eliminating training for ‘direct’ or ‘manual’ modes (where they are the backup; and relied upon to provide mechanical actuation inputs). Such systems may further reduce the cognitive load on pilots in safety-critical or stressful situations, since they can rely on persistent augmentation during all periods of operation. The systems are designed with sufficient redundancy that the vehicle may be operated in normal mode at all times. In contrast, conventional systems generally force operators to train in multiple backup modes of controlling an aerial vehicle.

The disclosed systems may reduce vehicle mass or cost (e.g., especially when compared to equivalently redundant systems). By co-locating multiple flight critical components within a single housing, systems can reduce the cable length, minimize the number of distinct connections required for vehicle integration (thereby improving ease of assembly), and allow use of less expensive sensors or processors without an electronics bay (e.g., as individual components can often require unique electrical or environmental protections).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium and processor executable) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module is a tangible component that may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for universal vehicle control through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A non-transitory computer-readable storage medium configured to store instructions, the instructions when executed by a processor of an aerial vehicle control and interface system cause the aerial vehicle control and interface system to:
generate a graphical user interface (GUI) comprising one or more aerial vehicle graphical flight instrument indicators, each indicator corresponding to an axis of movement of the aerial vehicle and displaying a range of allowable values for the axis of movement;
receive a user interaction corresponding to an instruction to modify navigation of the aerial vehicle to a value above a maximum allowable value or below a minimum allowable value of an axis of movement;
determine a hierarchical order of degradation of one or more additional axes of movement based on the instruction;
transmit one or more actuator commands to one or more actuators of the aerial vehicle based on the instruction and the determined hierarchical order of degradation; and
generate a status indicator for display at the GUI indicating that the aerial vehicle is operating in a degraded state.

2. The non-transitory computer-readable storage medium of claim 1, wherein the user interaction comprises maximum deflection of a mechanical controller through which the aerial vehicle is controlled.

3. The non-transitory computer-readable storage medium of claim 2, wherein the instructions further cause the aerial vehicle control and interface system to:
receive a second user interaction comprising a re-centering of the mechanical controller for at least a threshold period of time;
determine updated allowable values for each axis of movement;
transmit one or more updated actuator commands to the one or more actuators of the aerial vehicle based on the updated allowable values; and
generate a second status indicator for display at the GUI indicating that the aerial vehicle has returned to a normal operating state.

4. The non-transitory computer-readable storage medium of claim 3, wherein maximum and minimum values for each axis of movement cannot be exceeded when the aerial vehicle is in the normal operating state.

5. The non-transitory computer-readable storage medium of claim 1, wherein the instruction to modify navigation of the aerial vehicle is a speed modification, a lateral orientation modification, a heading modification, or a vertical position modification.

6. The non-transitory computer-readable storage medium of claim 1, wherein the range of allowable values for the axes of movement are dynamically adjusted during operation of the aerial vehicle.

7. The non-transitory computer-readable storage medium of claim 1, wherein the status indicator that the aerial vehicle is operating in the degraded state is one of a visual cue or an aural cue that a particular aircraft parameter is being degraded.

8. The non-transitory computer-readable storage medium of claim 1, wherein the instructions further cause the aerial vehicle control and interface system to:
determine, based on the user interaction corresponding to the instruction to modify navigation of the aerial vehicle, that an operator is maneuvering the aerial vehicle to avoid an in-flight incident.

9. The non-transitory computer-readable storage medium of claim 8, wherein the user interaction is a mechanical controller movement at an acceleration exceeding a threshold acceleration.

10. The non-transitory computer-readable storage medium of claim 1, wherein the instructions, when executed by the processor, further cause the aerial vehicle and control system to:
during operation of the aerial vehicle at an engine power below a threshold power value, detect a failure of the engine of the aerial vehicle for at least a threshold period of time, and
wherein the status indicator that the aerial vehicle is operating in the degraded state comprises an engine power indicator.

11. An aerial vehicle control and interface system comprising:
a universal vehicle control interface for an aerial vehicle, the universal vehicle control interface configured to:
display a graphical user interface (GUI) comprising one or more aerial vehicle graphical flight instrument indicators, each indicator corresponding to an axis of movement of the aerial vehicle and displaying a range of allowable values for the axis of movement; and
receive a user interaction corresponding to an instruction to modify navigation of the aerial vehicle to a value above a maximum allowable value or below a minimum allowable value of an axis of movement; and
a universal avionics control router configured to:
determine a hierarchical order of degradation of one or more additional axes of movement based on the instruction;
transmit one or more actuator commands to one or more actuators of the aerial vehicle based on the instruction and the determined hierarchical order of degradation; and
generate a status indicator for display at the GUI indicating that the aerial vehicle is operating in a degraded state.

12. The aerial vehicle control and interface system of claim 11, wherein the user interaction comprises maximum deflection of a mechanical controller through which the aerial vehicle is controlled.

13. The aerial vehicle control and interface system of claim 11, wherein:
the universal vehicle control interface is further configured to:
receive a second user interaction comprising a re-centering of a mechanical controller for at least a threshold period of time; and
the universal avionics control router is further configured to:
determine updated allowable values for each axis of movement;
transmit one or more updated actuator commands to the one or more actuators of the aerial vehicle based on the updated allowable values; and
generate a second status indicator for display at the GUI indicating that the aerial vehicle has returned to a normal operating state.

14. The aerial vehicle control and interface system of claim 11, wherein maximum and minimum values for each axis of movement cannot be exceeded when the aerial vehicle is in a normal operating state.

15. A non-transitory computer-readable storage medium configured to store instructions, the instructions when executed by a processor of an aerial vehicle control and interface system cause the aerial vehicle control and interface system to:
during operation of an aerial vehicle at an airspeed below a threshold value, detect a failure of at least one sensor of the aerial vehicle for at least a threshold duration;
automatically determine a hover trim position of a mechanical controller of the aerial vehicle;
receive input to modify navigation of the aerial vehicle from an operator of the aerial vehicle via the mechanical controller;
transmit one or more actuator commands to one or more actuators of the aerial vehicle based on the received input; and
update a graphical user interface (GUI) of the aerial vehicle to display an indication that the aerial vehicle is operating in a degraded state.

16. The non-transitory computer-readable storage medium of claim 15, wherein the threshold value comprises an effective translational lift airspeed and wherein the aerial vehicle operates in a hover-taxi phase when the airspeed is below the effective translational lift.

17. The non-transitory computer-readable storage medium of claim 15, wherein the hover trim position is automatically set to maintain a centered state of the mechanical controller.

18. The non-transitory computer-readable storage medium of claim 17, wherein, during the degraded state, the instructions further cause the aerial vehicle control and interface system to, responsive to detection of a release of the mechanical controller, modify operation of at least one of the one or more actuators to return the aerial vehicle to a stable hover.

19. The non-transitory computer-readable storage medium of claim 17, wherein the instructions further cause the aerial vehicle control and interface system to:
detect a return to normal operation of the at least one sensor of the aerial vehicle;
modify an operation of at least one of the one or more actuators based on the detected return to normal operation; and
update the GUI of the aerial vehicle to display an indication that the aerial vehicle is operating in a normal operating state.

20. The non-transitory computer-readable storage medium of claim 19, wherein the aerial vehicle control and interface system is configured to operate the aerial vehicle in a normal operating state when the airspeed meets the threshold value and Global Positioning System (GPS) is available.
